(19) United States
(12) Patent Application Publication
(10) Pub. No.: US 2026/0136162 A1
(43) Pub. Date: May 14, 2026

(54) METHODS FOR PEDESTRIAN-TO-VEHICLE COMMUNICATIONS

(71) Applicant: Harman International Industries, Incorporated, Stamford, CT (US)

(72) Inventor: Prasanna Kumar Bolisetty Yeswanth Naga, Bangalore (IN)

(21) Appl. No.: 18/945,405

(22) Filed: Nov. 12, 2024

(30) Foreign Application Priority Data
Sep. 13, 2023 (IN) 202341061549

(51) Int. Cl. H04W 4/40; H04W 4/02

(52) U.S. Cl. CPC H04W 4/40; H04W 4/02

(57) ABSTRACT

Methods and systems are provided for Vehicle-to-Everything (V2X) communications between a pedestrian carrying a mobile device configured for Pedestrian-to-Vehicle (P2V) communication and a vehicle. In particular, a method is proposed for determining whether the pedestrian has become a passenger of a vehicle, and in response to determining that the pedestrian has become a passenger, disabling Personal Safety Messages (PSMs) transmitted by the mobile device of the pedestrian/passenger to the vehicle. The methods may also be applied in reverse, to enable PSM transmission to be resumed by the mobile device if and/or when a passenger leaves a vehicle and becomes a pedestrian.

### CROSS REFERENCE TO RELATED APPLICATIONS

The present application claims priority to Indian Patent Application number 202341061549, entitled “METHODS FOR PEDESTRIAN-TO-VEHICLE COMMUNICATIONS”, and filed on Sep. 13, 2023. The entire contents of the above-listed application is hereby incorporated by reference for all purposes.

### FIELD

The disclosure relates to vehicle communications, and in particular, to Vehicle-to-Everything (V2X), cellular, and multi-access edge computing (MEC) communications.

### BACKGROUND

Vehicle-to-everything (V2X) systems are cooperative systems in which vehicles exchange information with other vehicles, e.g., via Vehicle-to-Vehicle (V2V) communication, with roadside infrastructure, e.g., via Vehicle-to-Infrastructure (V2I) communication, and/or with mobile devices of pedestrians, e.g., via Vehicle-to-Pedestrian (V2P) or Pedestrian-to-Vehicle (P2V) communication, in order to achieve higher levels of safety, comfort, and roadway efficiencies. While V2V communication may be used to enhance driver safety, V2I and P2V may play an important role in the dissemination of information to vehicles about a driving environment including pedestrian traffic. P2V communication may be carried out between a mobile device of a pedestrian and a vehicle. For example, a basic safety message (BSM) may be transmitted from the vehicle to the pedestrian, and/or a pedestrian safety message (PSM) may be transmitted from the mobile device to the vehicle. P2V communication may be used to alert a driver of the vehicle of a proximity of a pedestrian. However, in scenarios where a first pedestrian enters the vehicle and becomes a driver or passenger of the vehicle, P2V communication between the first pedestrian and the vehicle may result in false alerts being generated at the vehicle. As a result of the false alerts, P2V communication with a second pedestrian may not result in an alert being generated in a timely manner.

### SUMMARY

In one or more embodiments, a method for a mobile device comprises periodically transmitting Pedestrian Safety Messages (PSMs) to a vehicle, the PSMs including information used by the vehicle to determine whether to display an alert to a driver of the vehicle; and in response to detecting that the mobile device is inside the vehicle, stopping transmitting of the PSMs. In one embodiment, detecting whether the mobile device is inside the vehicle further comprises comparing a first speed and a first direction of the mobile device with a second speed and a second direction of the vehicle. If the first speed and the second speed are within a threshold speed difference, and the first direction and the second direction are within a threshold direction difference, it may be inferred that a pedestrian carrying the mobile device has entered the vehicle and is travelling with the vehicle, whereby transmission of the PSMs is disabled. Additionally or alternatively, the first speed may be compared with a threshold speed, such as a maximum walking speed of the pedestrian. The first speed and first direction of the mobile device may be calculated, for example, based on a change in location of the mobile device over a first duration, where the location is provided by a global positioning system (GPS) of the mobile device. The second speed and second direction of the vehicle may be calculated, for example, based on a change in location of the vehicle over a second duration, where the location of the vehicle is included in BSMs transmitted by the vehicle and received at the mobile device.

In other embodiments, detecting whether the mobile device is inside the vehicle additionally or alternatively comprises determining whether a wireless connection is established between the mobile device and a wireless device and/or computer system of the vehicle. For example, the wireless device may be a small cell installed in the vehicle, such as a femtocell. If the wireless connection is established, it may be inferred that the pedestrian carrying the mobile device has entered the vehicle and is travelling with the vehicle, whereby transmission of the PSMs is disabled.

Once transmitting of the PSMs stops, the PSMs remain disabled until the difference between the second speed of the vehicle and the first speed of the mobile device is greater than the threshold speed difference, the second direction of the vehicle and the first direction of the mobile device is greater than the threshold direction difference, and/or the wireless connection is no longer detected, at which point it may be inferred that the pedestrian has exited the vehicle, and transmission of the PSMs is resumed. In this way, in the case that a pedestrian carrying the mobile device and transmitting PSMs enters the vehicle and becomes a passenger, erroneous alerts may not be displayed to a driver of the vehicle with respect to a proximity of the pedestrian/passenger to the vehicle, which may interfere with legitimate alerts generated in response to a second pedestrian being within a threshold proximity to the vehicle or a trajectory of the vehicle. As a result, a safety of the driver and the second pedestrian or other pedestrians may be increased.

### BRIEF DESCRIPTION OF THE DRAWINGS

The disclosure may be better understood from reading the following description of non-limiting embodiments, with reference to the attached drawings, wherein below:

FIG. 1 shows an exemplary Vehicle-to-Everything (V2X) system, in accordance with one or more embodiments of the present disclosure;

FIG. 2 shows an example partial view of a vehicle cabin including an instrument panel, in accordance with one or more embodiments of the present disclosure;

FIG. 3 shows a block diagram of an example in-vehicle computing system of a vehicle configured to receive a PSM and/or generate a BSM, in accordance with one or more embodiments of the present disclosure;

FIG. 4 shows a framework of a V2X communication including a PSM, in accordance with one or more embodiments of the present disclosure;

FIG. 5 shows a diagram illustrating a first P2V communication scenario, as prior art;

FIG. 6 shows a diagram illustrating a second P2V communication scenario, as prior art;

FIG. 7 shows a diagram illustrating a third P2V communication scenario, as prior art;

FIG. 8 shows a diagram illustrating a fourth P2V communication scenario, in accordance with one or more embodiments of the present disclosure;

FIG. 9 shows a diagram illustrating a fifth P2V communication scenario, in accordance with one or more embodiments of the present disclosure;

FIG. 10A shows a flowchart illustrating a first method for controlling a P2V communication between a pedestrian and a vehicle, in accordance with one or more embodiments of the present disclosure;

FIG. 10B shows a flowchart illustrating a first method for controlling a P2V communication between a pedestrian and a vehicle, in accordance with one or more embodiments of the present disclosure; and

FIG. 11 is a timing diagram showing a sequence of events that occur as a pedestrian enters a vehicle.

### DETAILED DESCRIPTION

The following description relates to systems and methods for Vehicle-to-Everything (V2X) communication, and in particular, for Pedestrian-to-Vehicle (P2V) communication. Vehicle-to-everything (V2X) communication is the process of broadcasting basic safety messages (BSM) between a vehicle and any V2X device that may affect the vehicle. V2X communication also includes receiving pedestrian safety messages (PSM) at a vehicle from a pedestrian carrying a mobile device configured for the V2X communication. V2X communication allows for communication between the vehicle and other entities that may increase road safety, traffic efficiency, energy savings, avoidance of traffic violations, and reduce danger to pedestrians. V2X safety applications that are supported by a vehicle (e.g., a V2X communication system) provide a driver of the vehicle with an early alert/warning based on configurable thresholds. The thresholds are predefined and developed through different pilot tests, different configuration, different user experiences, different vehicle capabilities, different terrains, different lanes, different regions, different vehicle classes, and so on. A host vehicle may trigger an early warning/alert (e.g., 5 seconds ahead of a collision/threat/violation) by indicating to the driver when a remote vehicle dangerously approaches the host vehicle, or when a pedestrian may be in danger, for example.

V2X communication may rely on wireless connectivity with a Road-Side Unit (RSU) and/or a mobile device of a pedestrian. RSUs may be mounted at intersections and along roadways may broadcast various information (such as roadwork information, map information, and/or traffic-light information) to vehicles using V2I messaging. Such information may be used by in-vehicle V2I/P2V applications in order to improve driving, powertrain, and/or environmental efficiencies. Such information may also be used for safe operation of autonomous vehicles.

The vehicles, RSUs, and mobile devices used for V2X communication may be equipped with radio technologies, such as Dedicated Short Range Communication (DSRC) and/or Cellular V2X (CV2X) radio technologies, that may allow them to directly communicate with vehicles, such as via sidelink connections. Sidelink connections may have limited range, which may implicitly impact the nature of possible localization in the system. V2 I and/or P2V messages may be broadcasted over sidelink connections, which may be received by various vehicles in a coverage area of an RSU or mobile device, and may be processed by each of the vehicles in implementing various V2I/P2V use cases.

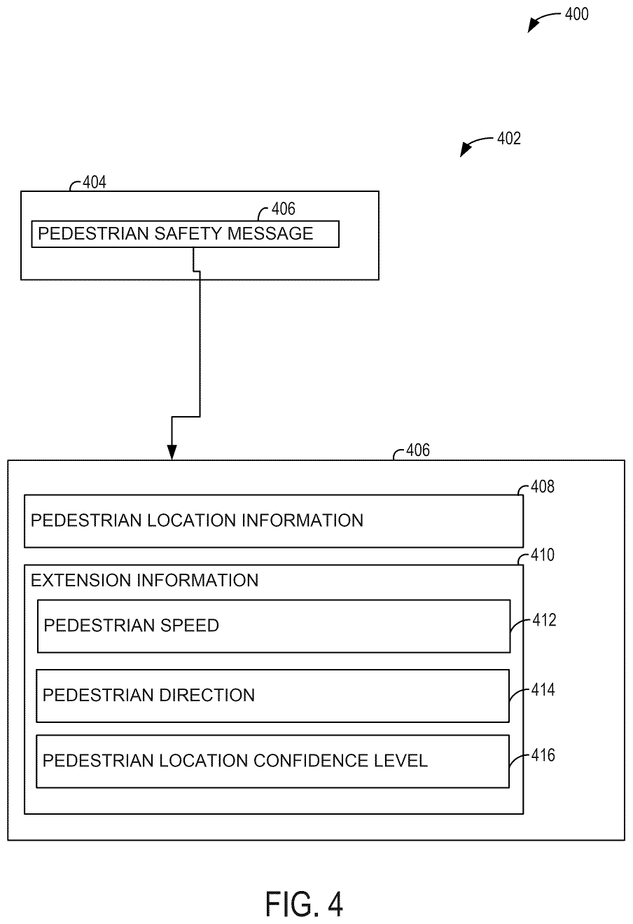

A P2V application installed on a mobile device may configure the mobile device to send PSMs and receive BSMs transmitted automatically from one or more vehicles within a range of the mobile device. The P2V application may be responsible for handling encoding and/or decoding of V2X standards-compliant messages and for implementing V2X networking standards and related protocols for transporting messages (e.g., over a DSRC radios and/or CV2X radio, for example, via a chip of the mobile device). In addition, the P2V application may implement V2X security components which comply formats for security credentials such as certificates, and may implement protocols and/or algorithms for secure signing and verification of V2X/P2V messages. In particular, a PSM may be generated in accordance with one or more standards, such as SAE Surface Vehicle Standards J2735 and/or J3161, IEEE standards 1609.2 and 1609.3, or a relevant regional standard, such as the PSM shown schematically by FIG. 4. The PSM may include information about a location of the pedestrian, such as a latitude, longitude, and elevation of the mobile device. In some embodiments, the PSM may also include, for example, information about a speed of the pedestrian (e.g., the mobile device carried by the pedestrian), a direction of the pedestrian, or other information that may be derived from changes in the location of the pedestrian.

For example, a pedestrian may be walking along a side of a route that a vehicle is travelling on. A mobile device of the pedestrian may be configured to broadcast PSMs, which may be received by vehicles within a range of the mobile device. For example, the range may be one kilometer. In various embodiments, the PSMs may be transmitted periodically by the mobile device (e.g., at 100 ms intervals). When the vehicle enters the range of the mobile device, the vehicle may receive a PSM transmitted by the mobile device. The PSM may indicate a location of the pedestrian in relation to the vehicle. The PSM may be received and analyzed at a computing system of the vehicle. Based on information in the PSM, the computing system may calculate or predict a proximity of the pedestrian to the vehicle as the vehicle passes the pedestrian. If the proximity is in a trajectory of the vehicle, or within a threshold proximity of a trajectory of the vehicle (e.g., 1 meter), the computing system may alert a driver of the vehicle to the presence of the pedestrian. The driver may view the alert, and may decrease a speed of the vehicle, for example.

Further, in some embodiments, the computing system may predict a trajectory of the pedestrian based on a change in location of the mobile device over a duration, from a plurality of PSMs transmitted by the mobile device over the duration. If the predicted trajectory indicates that the pedestrian may move into the trajectory of the vehicle, the alert may be generated. In this way, drivers of vehicles in a vicinity of the pedestrian may be alerted to the presence of the pedestrian with sufficient advance notice to take appropriate measures to ensure a safety of the pedestrian and the driver (e.g., apply brakes of the vehicle, steer the vehicle into a different lane of the route, etc.).

However, a problem may arise in a scenario where a pedestrian becomes a passenger of the vehicle. For example, a first pedestrian may approach and enter the vehicle. For example, the first pedestrian may be a friend of the driver, and the driver may pick up the first pedestrian. In such scenarios, the vehicle may continue to receive PSMs from the mobile device of the first pedestrian after the first pedestrian becomes a passenger of the vehicle. As a result, the driver may be periodically alerted of the first pedestrian's proximity to the vehicle, which may generate a distracting annoyance to the driver, as well as other vehicles receiving the PSMs.

Further, a second pedestrian may be within the threshold trajectory of the vehicle. For example, the second pedestrian may be crossing the route of the vehicle ahead of the vehicle. Because a first proximity of the first pedestrian/passenger to the vehicle may be closer than a second proximity of a second pedestrian to the vehicle, the driver may receive a first alert to the presence of the first pedestrian/passenger prior to receiving a second alert to the presence of the second pedestrian. As a result, the second alert may not be noticed by the driver. For example, the driver may assume that the second alert is an alert to the presence of the first pedestrian/passenger, and the driver may ignore the second alert. Alternatively, the second alert may be obfuscated or replaced by a third alert to the presence of the first pedestrian/passenger that is generated after the second alert.

This problem may be compounded in a scenario where a plurality of pedestrians enter the vehicle, such as when the vehicle is a bus, where so many alerts may be generated that it may be difficult or impossible for the driver to distinguish an alert related to a pedestrian in front of the bus from pedestrians/passengers on the bus.

To address this problem, methods and systems are proposed for determining whether a pedestrian has become a passenger of a vehicle, and in response to determining that the pedestrian has become a passenger, disabling PSMs transmitted by a mobile device of the pedestrian/passenger. The methods may also be applied in reverse, to enable PSM transmission to be resumed by the mobile device if and/or when a passenger leaves a vehicle and becomes a pedestrian.

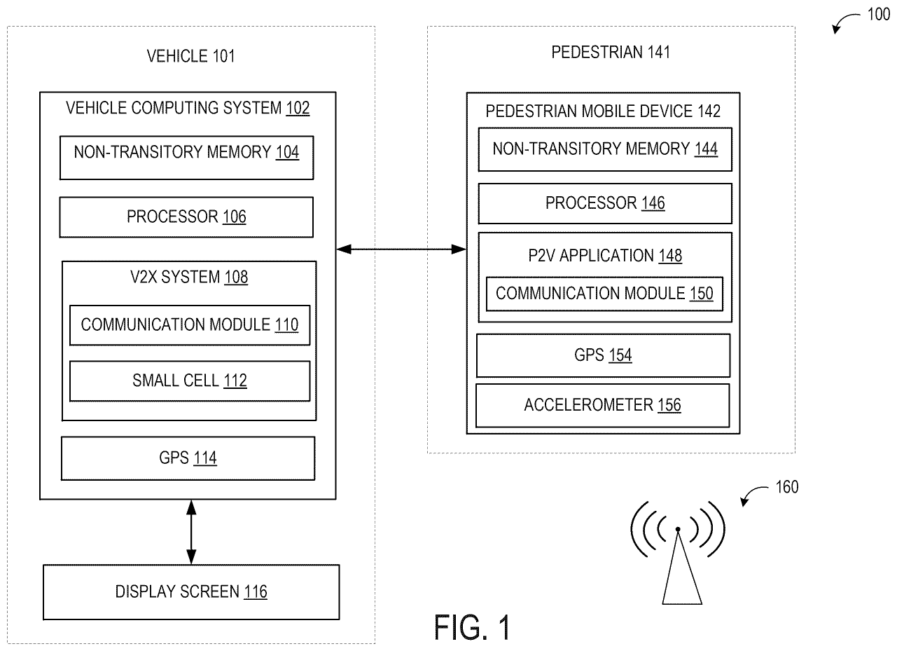

FIG. 1 shows a P2V ecosystem 100, including a vehicle computing system 102 of a vehicle 101 and a pedestrian mobile device 142 of a pedestrian 141. BSM and PSM messages may be transmitted between vehicle computing system 102 and pedestrian mobile device 142 using V2P/P2V communication. Vehicle 101 may be a car, a bus, a truck, or a different type of machinery or vehicle operated by an operator. Vehicle 101 may be powered by an internal combustion engine, or vehicle 101 may be an electric vehicle powered by an electrical power source, or vehicle 101 may be a hybrid vehicle powered by both an internal combustion engine and an electrical power source. Vehicle 101 may also be a specialized vehicle used in a specific environment, such as, for example, a golf cart or transportation vehicle used in certain areas of a private facility such as an indoor facility. Vehicle 101 may be operated on public and/or private roads and highways, and in general, may be any type of vehicle operated by an operator.

Vehicle computing system 102 includes one or more processors 106 configured to execute machine readable instructions stored in non-transitory memory 104. Similarly, pedestrian mobile device 142 includes one or more processors 146 configured to execute machine readable instructions stored in a non-transitory memory 144 of pedestrian mobile device 142. Memory 104 and other memory referred to herein may include one or more data storage structures, such as optical memory devices, magnetic memory devices, or solid-state memory devices, for storing programs and routines executed by processor(s) 106 to carry out various functionalities disclosed herein. Memory 104 may include any desired type of volatile and/or non-volatile memory such as, for example, static random access memory (SRAM), dynamic random access memory (DRAM), flash memory, read-only memory (ROM), etc.

Processor(s) 106 and other processors referred to herein may be any suitable processor, processing unit, or microprocessor, for example. Processor(s) 106 may be a multi-processor system, and, thus, may include one or more additional processors that are identical or similar to each other and that are communicatively coupled via an interconnection bus. Processor(s) 106 may be single core or multi-core, and the programs executed thereon may be configured for parallel or distributed processing. In some embodiments, processor(s) 106 may optionally include individual components that are distributed throughout two or more devices, which may be remotely located and/or configured for coordinated processing. In some embodiments, one or more aspects of processor(s) 106 may be virtualized and executed by remotely-accessible networked computing devices configured in a cloud computing configuration.

Vehicle computing system 102 may include a V2X communication system 108, also referred to herein as V2X system 108, which may include a communication module 110 and a small cell 112. Vehicle computing system 102 may be configured to communicate with pedestrian mobile device 142 via P2V communication using V2X system 108. For such purposes, V2X system 108 may include a communication module 110, which may manage wireless communication between vehicle computing system 102 and pedestrian mobile device 142 and/or other communication modules of other vehicles, RSUs, and/or mobile devices configured to communicate via V2X communication. Similarly, pedestrian mobile device 142 may be configured to communicate with vehicle computing system 102 via a P2V application 148. P2V application 148 includes a communication module 150, which may manage wireless communication between pedestrian mobile device 142 and vehicle computing system 102 and/or other communication modules of other vehicles, RSUs, and/or mobile devices configured to communicate via V2X communication. For example, communication module 150 may transmit one or more PSMs from pedestrian mobile device 142 to communication module 110, which may communicate a location of pedestrian mobile device 142 (e.g., a location of pedestrian 141) to vehicle computing system 102. If pedestrian 141 is within a threshold distance of vehicle 101 or a trajectory of vehicle 101, V2X system 108 may generate an alert, which may be displayed to a driver of vehicle 101 via a display screen 116 of vehicle 101, as described above. For example, display screen 116 may include a dashboard display of vehicle 101, and the alert may be generated on a portion of the dashboard display.

Communication modules 110 and 150 may support wireless communication between pedestrian mobile device 142 and vehicle computing system 102. The wireless communication may rely on one or more of various wireless technologies (e.g., radio frequency, infrared, near field communication (NFC), etc.). For example, a wireless connection may be established via a radio frequency (RF) link that supports bidirectional communication, whereby RF signals may be transmitted from communication module 150 and received at communication module 110, and/or RF signals may be transmitted by communication module 110 and received at communication module 150. In various examples, communication module 150 may communicate with communication module 110 (and vice-versa) via radio technologies such as Dedicated Short Range Communication (DSRC) and/or cellular V2X (CV2X) communications, (e.g., sidelink connections via PC5 interface/LTE). Communication module 150 may communicate via a wireless local area network (LAN) or wide area network (WAN) using any past, present, or future communication protocol (e.g., BLUETOOTH™, USB 2.0, USB 3.0, etc.). In some examples, communication module 110 may communicate with communication module 150 of P2V application 148 of pedestrian mobile device 142 via a wireless network 160. In various embodiments, wireless network 160 may be or include the Internet.

Small cell 112 may provide occupants of vehicle 101 increased coverage for cellular data. For example, small cell 112 may include SIM card of a Telematics Control Unit (TCU) of a vehicle used for enhanced 911 services. In various embodiments, small cell 112 may be a femtocell included in vehicle 101, which may have greater coverage with less signal loss.

Vehicle computing system 102 may further include a global positioning system (GPS) 114. For example, GPS 114 may be included in a navigational guidance system of vehicle 101. GPS 114 may be used by vehicle computing system 102 to determine a location of vehicle 101 as vehicle 101 moves along a route. A first location of vehicle 101 may be compared to a second location of pedestrian 141, one or more RSUs within a threshold distance of vehicle 101, and/or one or more other vehicles within the threshold distance.

Pedestrian mobile device 142 may include a GPS 154. GPS 154 may indicate the second location of pedestrian 141, for comparison with the first location. Additionally or alternatively, pedestrian mobile device 142 may include an accelerometer 156, which may indicate an acceleration of pedestrian mobile device 142 in an instantaneous rest frame of pedestrian mobile device 142 (e.g., as opposed to an acceleration within a fixed coordinate system). In some embodiments, accelerometer 156 may be used to determine a movement of pedestrian 141 in a direction, such as towards a trajectory of vehicle 101. The movement of pedestrian 141 may be included in a PSM generated by P2V application 148. The PSM may be received by V2X system 108 (e.g., via communication modules 110 and 150). In response to the movement indicating that pedestrian 141 is moving towards the trajectory of vehicle 101, V2X system 108 may generate an alert to the driver to be displayed on display screen 116.

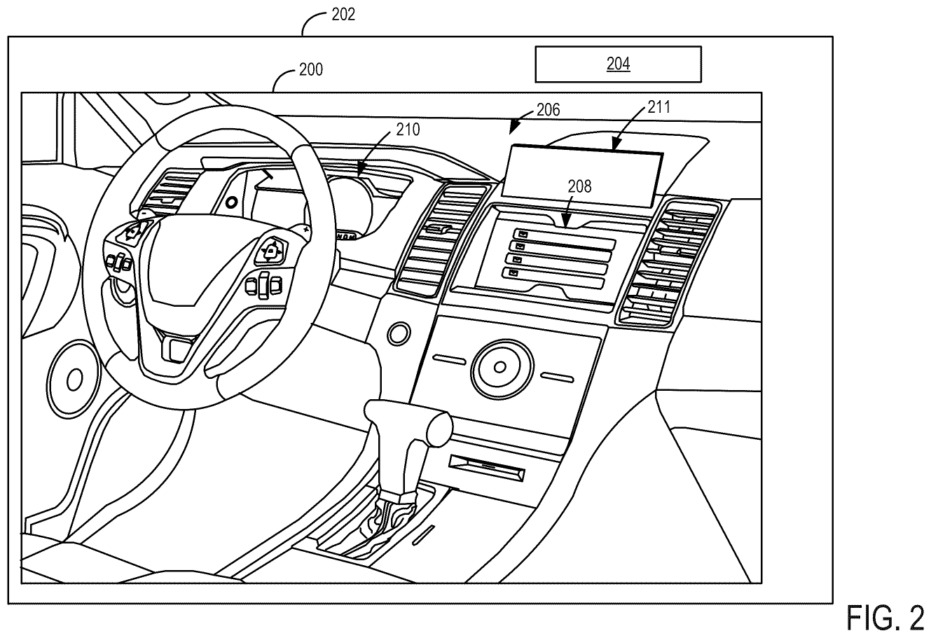

FIG. 2 shows an example partial view of an interior of a cabin 200 of a vehicle 202, in which a driver and/or one or more passengers may be seated. Vehicle 202 may be similar to or the same as vehicle 101 shown by FIG. 1 and described above.

Vehicle 202 of FIG. 2 may be a motor vehicle including drive wheels (not shown) and a power source 204 configured to provide torque to the drive wheels, such as an internal combustion engine and/or battery. In examples in which the power source 204 includes an internal combustion engine, the internal combustion engine may include one or more combustion chambers which may receive intake air via an intake passage and exhaust combustion gases via an exhaust passage. Vehicle 202 may be a road automobile, among other types of vehicles. In some examples, vehicle 202 may include a hybrid propulsion system including an energy conversion device operable to absorb energy from vehicle motion and/or the engine and convert the absorbed energy to an energy form suitable for storage by an energy storage device. Vehicle 202 may be a fully electric vehicle in some examples, incorporating fuel cells, solar energy capturing elements, and/or other energy storage systems for powering the vehicle.

As shown, the vehicle 202 may include an instrument panel 206 with various displays and controls accessible to a human driver (also referred to as the user and/or occupant) of vehicle 202. For example, instrument panel 206 may include a touch screen 208 of an in-vehicle computing system (e.g., vehicle computing system 102 of FIG. 1) and an instrument cluster 210. Touch screen 208 may receive user input to the in-vehicle computing system for controlling visual display output, user preferences, control parameter selection, and so on. While the example system shown in FIG. 2 includes controls that may be performed via a user interface of the in-vehicle computing system, such as touch screen 208, without a separate control panel, in other embodiments, the vehicle may include additional control panels. In some embodiments, one or more hardware elements of in-vehicle computing system 209, such as touch screen 208, a display screen 211 (e.g. display screen 116), various control dials, knobs and buttons, memory, processor(s), and any interface elements (e.g., connectors or ports) may form an integrated head unit that is installed in instrument panel 206 of the vehicle. The head unit may be fixedly or removably attached in instrument panel 206. In additional or alternative embodiments, one or more hardware elements of in-vehicle computing system 209 may be modular and may be installed in multiple locations of the vehicle.

During operation of vehicle 202, the in-vehicle computing system may be configured to receive electronic signals from the various sensors of the vehicle 202, in some examples. Additionally, the in-vehicle computing system may be configured to generate and transmit a BSM, as a V2X communication, in accordance with SAE Surface Vehicle Standard J2735 and/or other related/supported standards of a particular region of vehicle 202, as described above. The BSM may be transmitted to other vehicles in an environment of vehicle 202. The in-vehicle computing system may be configured to receive PSMs from a mobile device of a pedestrian in the environment. If a PSM received from the mobile device indicates that the pedestrian is within a threshold proximity of vehicle 202 or a trajectory of vehicle 202, an alert may be generated and displayed on display screen 211. The driver may view the alert on display screen 211, and in some cases, adjust an operation of vehicle 202.

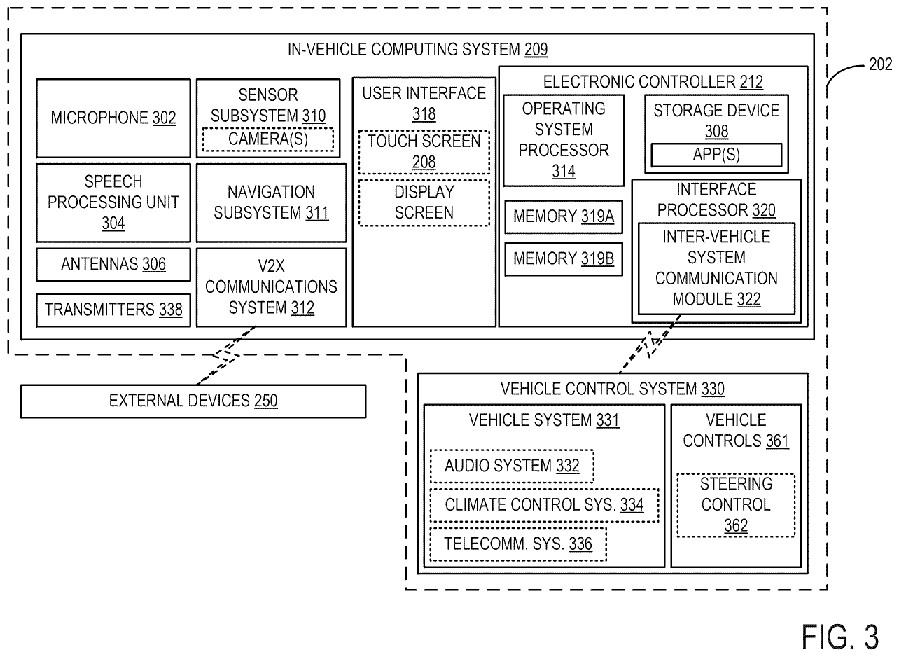

FIG. 3 shows a block diagram of an in-vehicle computing system 209 integrated inside vehicle 202, where in-vehicle computing system 209 may be a non-limiting example of vehicle computing system 102 of vehicle 101 of FIG. 1. In-vehicle computing system 209 may be referred to herein as a controller and/or electronic controller in some examples. In-vehicle computing system 209 may perform one or more of the methods described herein in some embodiments. In-vehicle computing system 209 may include, or be coupled to, various vehicle systems, sub-systems, hardware components, as well as software applications and systems that are integrated in, or integratable into, vehicle 202.

In-vehicle computing system 209 may include one or more processors including an operating system processor 314 and an interface processor 320. Operating system processor 314 may execute an operating system on in-vehicle computing system 209, and control input/output, display, and other operations of in-vehicle computing system 209. Interface processor 320 may interface with a vehicle control system 330 via an inter-vehicle system communication module 322.

Inter-vehicle system communication module 322 may output data to one or more other vehicle systems 331 and/or one or more other vehicle control elements 361, while also receiving data input from other vehicle systems 331 and other vehicle control elements 361, e.g., by way of vehicle control system 330. When outputting data, inter-vehicle system communication module 322 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System (GPS) sensors, and so on), digital signals propagated through vehicle data networks (such as an engine controller area network (CAN) bus through which engine related information may be communicated, a climate control CAN bus through which climate control related information may be communicated, and a multimedia data network through which multimedia data is communicated between multimedia components in the vehicle), and so on. For example, in-vehicle computing system 209 may retrieve from the engine CAN bus the current speed of the vehicle estimated by the wheel sensors, a power state of the vehicle via a battery and/or power distribution system of the vehicle, an ignition state of the vehicle, a condition of one or more air bags of the vehicle, a condition of hazard lights of the vehicle, a condition of the power source 204 (shown by FIG. 2) of the vehicle, and so on. In addition, other interfacing means such as Ethernet may be used as well without departing from the scope of this disclosure.

A storage device 308 may be included in in-vehicle computing system 209 to store data such as instructions executable by operating system processor 314 and/or interface processor 320 in non-volatile form. Storage device 308 may store application data to enable in-vehicle computing system 209 to run an application for connecting to a cloud-based server and/or collecting information for transmission to the cloud-based server. The application may retrieve information gathered by vehicle systems/sensors, input devices (e.g., a user interface 318), data stored in one or more storage devices, such as a volatile memory 319A or a non-volatile memory 319B, devices in communication with the in-vehicle computing system, and so on. In-vehicle computing system 209 may further include a volatile memory 319A. Volatile memory 319A may be random access memory (RAM). Non-transitory storage devices, such as non-volatile storage device 308 and/or non-volatile memory 319B (e.g., non-transitory memory), may store instructions and/or code that, when executed by a processor (e.g., operating system processor 314 and/or interface processor 320), controls in-vehicle computing system 209 to perform one or more of the actions described in the disclosure.

A microphone 302 may be included in In-vehicle computing system 209 to receive voice commands from a user, to measure ambient noise in the vehicle, and so on. A speech processing unit 304 may process voice commands, such as the voice commands received from microphone 302. In some embodiments, in-vehicle computing system 209 may also be able to receive voice commands and sample ambient vehicle noise using a microphone included in an audio system 332 of the vehicle.

One or more additional sensors may be included in a sensor subsystem 310 of in-vehicle computing system 209. For example, sensor subsystem 310 may include a camera, such as a rear view camera for assisting a user in parking the vehicle and/or a cabin camera for identifying a user (e.g., using facial recognition and/or user gestures). Sensor subsystem 310 of in-vehicle computing system 209 may communicate with and receive inputs from various vehicle sensors and may further receive user inputs. For example, the inputs received by sensor subsystem 310 may include transmission gear position, transmission clutch position, gas pedal input, brake input, transmission selector position, vehicle speed, engine speed, mass airflow through the engine, ambient temperature, intake air temperature, and so on, as well as inputs from climate control system sensors (such as heat transfer fluid temperature, antifreeze temperature, fan speed, passenger compartment temperature, desired passenger compartment temperature, ambient humidity, and so on), an audio sensor detecting voice commands issued by a user, a fob sensor receiving commands from and optionally tracking the geographic location/proximity of a fob of the vehicle, and so on.

While certain vehicle system sensors may communicate with sensor subsystem 310 alone, other sensors may communicate with both sensor subsystem 310 and vehicle control system 330, or may communicate with sensor subsystem 310 indirectly via vehicle control system 330. A navigation subsystem 311 of in-vehicle computing system 209 may generate, transmit, receive, and/or process navigation information such as location information (e.g., via a GPS sensor and/or other sensors from sensor subsystem 310), route guidance, traffic information, point-of-interest (POI) identification, and/or provide other navigational services for the driver.

A V2X communications system 312 of in-vehicle computing system 209 may be coupleable to and/or communicate with one or more external devices 250 located external to vehicle 202. V2X communications system 312 may be the same as or similar to V2X system 108 of vehicle computing system 102 of FIG. 1. The V2X communications system is in electronic communication with the electronic controller 212 of the vehicle 202 and may be commanded by the electronic controller 212 to generate and transmit V2X communications, similar to the examples described above. As one example, the electronic controller 212 may command the V2X communications system 312 to generate and transmit a BSM to one or more external devices 250. The external devices 250 may include extra-vehicular devices that are separate from and located externally to the vehicle 202, such as mobile devices (e.g., cellular phones) carried by observers of the vehicle 202 (e.g., pedestrians), RSUs arranged along roadways, receivers of vehicles external to the vehicle 202 (e.g., other vehicles), and so on. The V2X communications system 312 may communicate wirelessly with the external devices 250 via a communication module, such as communication module 110 of FIG. 1.

Vehicle control system 330 may include controls for controlling aspects of various vehicle systems 331 involved in different in-vehicle functions. These may include, for example, controlling aspects of vehicle audio system 332, aspects of a climate control system 334, aspects of a telecommunication system 336, and so on.

Vehicle control system 330 may also include controls for adjusting the settings of various vehicle control elements 361 (or vehicle controls, or vehicle system control elements) related to the engine and/or auxiliary elements within the cabin of the vehicle, such as one or more steering wheel controls 362 (e.g., steering wheel-mounted audio system controls, cruise controls, windshield wiper controls, headlight controls, turn signal controls, and so on), instrument panel controls, microphone(s), accelerator/brake/clutch pedals, a gear shift, door/window controls positioned in a driver or passenger door, seat controls, cabin light controls, audio system controls, cabin temperature controls, and so on. Vehicle control elements 361 may also include internal engine and vehicle operation controls (e.g., engine controller module, actuators, valves, and so on) that are configured to receive instructions via the CAN bus of the vehicle to change operation of one or more of the engine, exhaust system, transmission, and/or other vehicle system.

In-vehicle computing system 209 may further include one or more antennas 306. The in-vehicle computing system may obtain broadband wireless internet access via antennas 306, and may further receive broadcast signals such as radio, television, weather, traffic, and the like. In some examples, one or more antennas may be included with the V2X communications system 312 and may be configured to receive V2X communications from vehicles external to the vehicle 202, from RSUs, and/or from pedestrian devices (e.g., pedestrian mobile device 142). In-vehicle computing system 209 may receive positioning signals such as GPS signals via antennas 306. The in-vehicle computing system may also receive wireless commands via radio frequency (RF) such as via antennas 306 or via infrared or other means through appropriate receiving devices. In some embodiments, antenna 306 may be included as part of audio system 332 or telecommunication system 336. Additionally, antenna 306 may provide AM/FM radio signals to external devices 250, in some examples.

The vehicle 202 further includes one or more transmitters 338. In some examples, one or more of the transmitters 338 may be integrated together with one or more of the antennas 306 to form one or more transceivers configured to generate and transmit V2X communications, and receive and process V2X communications, through V2X communications system 312.

One or more elements of in-vehicle computing system 209 may be controlled by a user via user interface 318. User interface 318 may include a graphical user interface presented on a touch screen, such as touch screen 208 and/or display screen 211 of FIG. 2, and/or user-actuated buttons, switches, knobs, dials, sliders, and so on. For example, user-actuated elements may include steering wheel controls, door and/or window controls, instrument panel controls, audio system settings, climate control system settings, and the like. A user may also interact with one or more applications of in-vehicle computing system 209 via user interface 318. In addition to receiving a user's vehicle setting preferences on user interface 318, vehicle settings selected by in-vehicle control system 330 may be displayed to a user on user interface 318. Notifications and other messages (e.g., received messages), as well as navigational assistance, may be displayed to the user on a display of the user interface. User preferences/information and/or responses to presented messages may be performed via user input to the user interface.

Although the electronic controller 212 is shown including the operating system processor 314, memory 319A, memory 319B, and so on, in some embodiments the electronic controller 212 may include a different number and/or configuration of components. For example, the electronic controller 212 may additionally be integrated with the one or more antennas 306, the one or more transmitters 338, and so on.

FIG. 4 shows a block diagram 400 schematically illustrating a P2V communication 402 including a PSM 406. P2V communication 402 may be formatted (e.g., structured) in accordance with SAE Surface Vehicle Standard J2735, and may be generated and transmitted utilizing a DSRC medium, in some examples. P2V communication 402 may be generated and transmitted by a mobile device of a pedestrian, and P2V communication 402 may be received at a vehicle in a vicinity of the pedestrian. P2V communication 402 may be generated and transmitted by a P2V application of the mobile device, such as P2V application 148 of pedestrian mobile device 142 shown by FIG. 1 and described above.

P2V communication 402 carries a P2V message 404 (e.g., structure) that may include a plurality of different data frames and data elements configured to provide an indication of conditions of the pedestrian mobile device. The pedestrian mobile device conditions as described herein refer to conditions of the pedestrian mobile device generating and transmitting P2V communication 402. The P2V message 404 is formatted in accordance with section 5.1 of SAE Surface Vehicle Standard.

In one example, P2V message 404 may be formatted as shown:

MessageFrame ::= SEQUENCE {
messageId MESSAGE-ID-AND-TYPE.&id({MessageTypes}),
value MESSAGE-ID-AND-TYPE.&Type({MessageTypes}{@.messageId}),
...
}
MESSAGE-ID-AND-TYPE ::= CLASS {
&id DSRCmsgID UNIQUE,
&Type
} WITH SYNTAX {&Type IDENTIFIED BY &id}

P2V message 404 includes a PSM 406 stored therein. PSM 406 includes pedestrian location information 408, and may further include an extension information 410. PSM 406 may be formatted in accordance with section 5.2 of SAE Surface Vehicle Standard J2735.

Pedestrian location information 408 may include a latitude, longitude, and/or elevation of the pedestrian mobile device generating and transmitting PSM 406. In various embodiments, pedestrian location information 408 may be generated by or using a GPS of the mobile device (e.g., GPS 154 of FIG. 1). Pedestrian location information 408 may be stored within a BSMcoreData data frame of PSM 406, in some examples, as defined by section 5.2 of SAE Surface Vehicle Standard J2735. For example, the latitude may be stored in a latitude data element (e.g., “lat”) of the BSMcoreData data frame, the longitude may be stored in a longitude data element (e.g., “long”) of the BSMcoreData data frame, and the elevation may be stored in an elevation data element (e.g., “elev”) of the BSMcoreData data frame. In general, common fields may be filled in and can be added to the PSM structure, where the structure is similar to BSMs and been decodable by vehicles.

Extension information 410 may be a BSMpartIIExtension content (e.g., data frame) of PSM 406, in accordance with section 5.2 of SAE Surface Vehicle Standard J2735. In various embodiments, extension information 410 may include additional information of the mobile device that may be used by a vehicle to determine whether to display an alert to a driver of the vehicle based on PSM 406. For example, extension information 410 may include a pedestrian speed 412, and/or a pedestrian direction 414. In some examples, pedestrian speed 412 and pedestrian direction 414 may be calculated based on a measured change in the location of the pedestrian over a duration, based on GPS data. Additionally or alternatively, pedestrian speed 412 may be determined based on accelerometer data generated by an accelerometer of the pedestrian mobile device. In some embodiments, either or both of pedestrian speed 412 and pedestrian direction 414 may be retrieved from one or more smart apps running on the mobile device. A type, size, behavior, etc., and/or an operation performed with respect to the pedestrian may also be embedded in PSM 406.

In some embodiments, extension information 410 may include a pedestrian location confidence level 416, where pedestrian location confidence level may indicate a degree of confidence that pedestrian location information 408 is accurate. In various embodiments, pedestrian location confidence level 416 may be based on a semi major axis and semi minor axis of the location of the mobile device provided by the GPS of the mobile device. For example, if the semi major axis and semi minor axis are less than 2.0, pedestrian location confidence level 416 may be higher, and if the semi major axis and semi minor axis are greater than 2.0, pedestrian location confidence level 416 may be lower. In some examples, pedestrian location confidence level 416 may be a number between 1 and 10. If pedestrian location confidence level 416 is lower than a threshold value (e.g., 2), pedestrian location data may be alternatively extracted from System Information Block (SIB) data corresponding to a cellular connection of the mobile device, in one example.

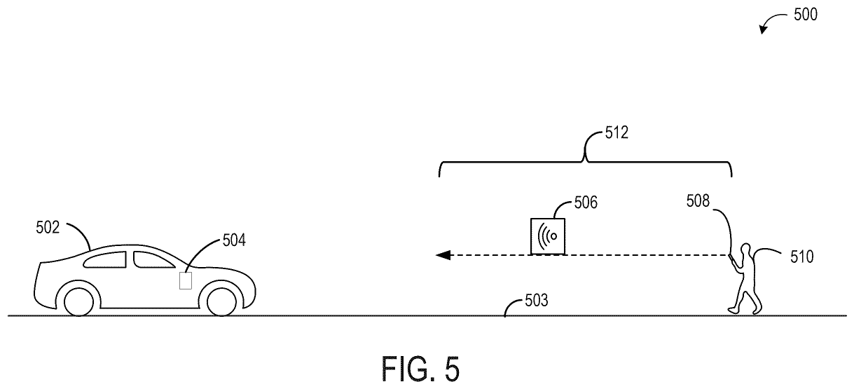

FIGS. 5-9 show various P2V communication scenarios in which a mobile device of a pedestrian communicates with a V2X communications system of a vehicle at different points in time as the vehicle approaches the pedestrian. It should be appreciated that FIGS. 5-9 are for illustrative purposes and may not be drawn to scale.

Referring now to FIG. 5, a diagram 500 illustrating a first P2V communication scenario is shown. In the example shown, a vehicle 502 is driving along a road 503, where vehicle 502 may be a non-limiting example of vehicle 101 of FIG. 1 and/or vehicle 202 of FIG. 2. Vehicle 502 may be an automobile powered by an internal combustion engine and/or battery. However, in some examples, the vehicle 502 may be a different type of vehicle (e.g., a motorcycle). In each example, the vehicle 502 is configured to communicate wirelessly with other devices external to the vehicle 502 via a V2X communications system 504 of a computing system of vehicle 502 (e.g., V2X system 108 of vehicle computing system 102 of FIG. 1).

A pedestrian 510 (e.g., pedestrian 141) is walking along a side of road 503. Pedestrian 510 has a mobile device 508 (e.g., pedestrian mobile device 142) that is configured to communicate via P2V/V2P communications with vehicles including a V2X communications system, such as vehicle 502. As pedestrian 510 walks, mobile device 508 transmits PSM messages that may be received by vehicles within a range 512 of pedestrian 510. Specifically, mobile device 508 transmits a V2X wireless signal via a V2X application (e.g., P2V application 148) running on mobile device 508. The V2X wireless signal may be a radio signal, in some examples, transmitted via a transceiver of mobile device 508. The contents of the V2X wireless signal may be generated having the format of a PSM in accordance with SAE Surface Vehicle Standard J2735. The PSM may include location information of mobile device 508, such as a latitude, a longitude, and/or an elevation of mobile device 508. In some embodiments, the PSM may also include speed and/or direction information of mobile device 508, as described above in reference to FIG. 4.

In some embodiments, the PSMs may be generated by mobile device 508 automatically and regularly (e.g., at 100 ms intervals). In the example depicted in FIG. 5, a plurality of PSMs 506 are transmitted by mobile device 508. V2X communications system 504 may include a receiver (e.g., a transceiver), one or more processors electronically coupled to the receiver, and non-transitory memory including instructions stored thereon that when executed, cause the one or more processors to process each PSM of the plurality of PSMs 506. However, PSMs 506 are not received at V2X communications system 504, due to vehicle 502 being outside of range 512. In one embodiment, range 512 is one kilometer. Thus, a distance between pedestrian 510 and vehicle 502 may be sufficiently great that vehicle 502 poses no risk to pedestrian 510.

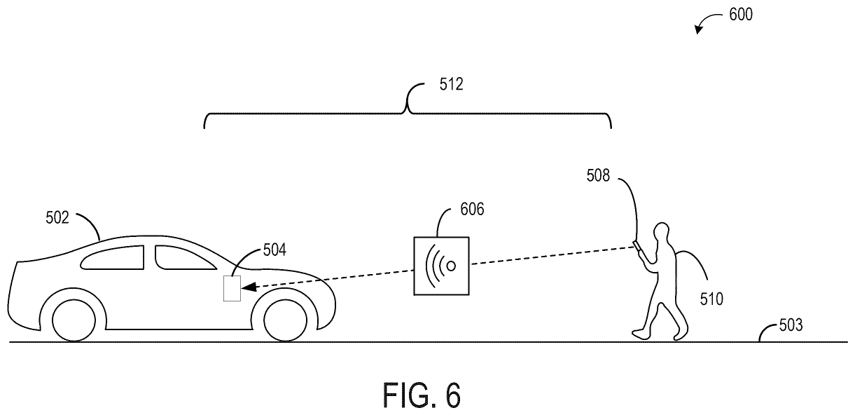

FIG. 6 shows a diagram 600 illustrating a second P2V communication scenario involving pedestrian 510 and vehicle 502 of FIG. 5, occurring at a time after the first P2V communication scenario of FIG. 5. In FIG. 6, vehicle 502 is approaching pedestrian 510 along road 503 and is within range 512, whereby a plurality of PSMs 606 transmitted by mobile device 508 is received at V2X communications system 504. When PSMs 606 are received, V2X communications system 504 may predict a first trajectory of pedestrian 510, based on a speed and direction of pedestrian 510. In some embodiments, the speed and direction of pedestrian 510 may be included in each PSM of PSMs 606 (e.g., pedestrian speed 412 and pedestrian direction 414). In other embodiments, the speed and direction of pedestrian 510 may be calculated by V2X communications system 504 based on changes in a location of pedestrian 510 over various PSMs 606. For example, V2X communications system 504 may compare a first location of pedestrian 510 (e.g., based on the latitude and longitude of mobile device 508 included in a first PSM 606) with one or more subsequent locations of pedestrian 510 included in a subsequent PSMs 606 received from mobile device 508 over a duration, to predict the first trajectory and estimate the first speed of pedestrian 510.

Concurrently, V2X communications system 504 may predict a second trajectory of vehicle 502, for example, based on a latitude and longitude of vehicle 502 received from a GPS of vehicle 502 (e.g., GPS 114) over the duration. V2X communications system 504 may determine whether the second trajectory of vehicle 502 intersects with the first trajectory of mobile device 508, based on a second speed of vehicle 502 (e.g., as measured by sensors of vehicle 502) and the first speed of pedestrian 510. If the second trajectory intersects with the first trajectory within a time frame that could pose a risk to pedestrian 510, V2X communications system 504 may display an alert to a driver of vehicle 502, for example, on a display of vehicle 502 (e.g., display screen 116).

For example, V2X communications system 504 may receive a first PSM from mobile device 508, indicating a first position of pedestrian 510, where at the first position pedestrian 510 is at a crosswalk of road 503 six feet from a curb of road 503. Over a duration of 10 seconds, V2X communications system 504 may receive additional PSMs from mobile device 508, at a rate of 10 PSMs per second, where the additional PSMs indicate subsequent positions of pedestrian 510 over the duration of 10 seconds. V2X communications system 504 may plot the subsequent positions of pedestrian 510 to determine the first trajectory and the first speed of pedestrian 510. The subsequent positions of pedestrian 510 may be positions that are increasingly close to an edge of road 503. Based on the predicted first trajectory, V2X communications system 504 may determine that pedestrian 510 is preparing to cross road 503 in front of vehicle 502. Concurrently, V2X communications system 504 may predict the second trajectory of vehicle 502, over the same duration of 10 seconds. V2X communications system 504 may determine that the second trajectory of vehicle 502 intersects with the first trajectory of mobile device 508, based on the second speed of vehicle 502 and the first speed of pedestrian 510. Further, based on the first speed and the second speed, V2X communications system 504 may determine that a probability that vehicle 502 will be within a threshold proximity (e.g., 2 meters) of pedestrian 510 when the first trajectory of mobile device 508 intersects with the second trajectory of vehicle 502 is greater than a threshold probability (e.g., 90%). As a result, V2X communications system 504 may display an alert to the driver of vehicle 502 on a dashboard display screen of vehicle 502 (e.g., display screen 211 of FIG. 2).

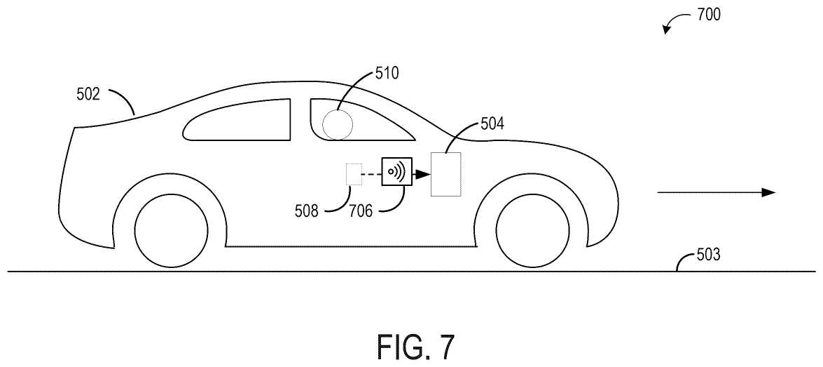

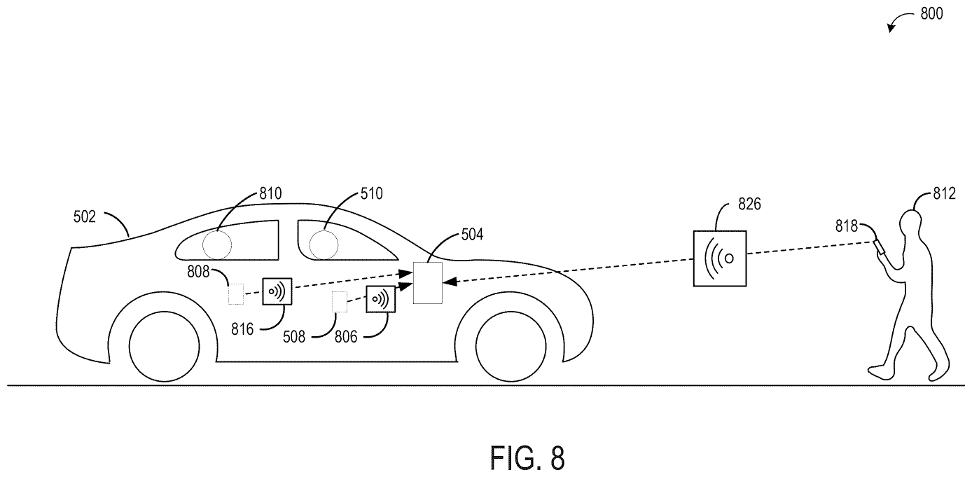

FIG. 7 shows a diagram 700 illustrating a third P2V communication scenario involving pedestrian 510 and vehicle 502 of FIGS. 5 and 6, occurring at a time after the second P2V communication scenario of FIG. 6. In FIG. 7, pedestrian 510 has entered vehicle 502 as a passenger in vehicle 502, and vehicle 502 is continuing to travel on road 503 and is in motion. As such, mobile device 508 is within an interior of a cabin of vehicle 502. However, mobile device 508 continues to transmit PSM messages. In particular, mobile device 508 transmits a plurality of PSMs 706, which is received at V2X communications system 504. When PSMs 706 are received at V2X communications system 504, V2X communications system 504 may determine that pedestrian 510 is within a threshold proximity of vehicle 502 (e.g., 1-2 meters). As a result of V2X communications system 504 determining that pedestrian 510 is within the threshold proximity of vehicle 502, V2X communications system 504 may erroneously display one or more alerts to the driver of vehicle 502. For example, a first alert may be displayed in response to a first PSM 706 received at V2X communications system 504; a second alert may be displayed in response to a second PSM 706 received at V2X communications system 504; a third alert may be displayed in response to a third PSM 706 received at V2X communications system 504; and so on. Alternatively, in some embodiments, an alert may be generated continuously in accordance with safety algorithms of vehicle 502 when pedestrian 510 is within the threshold proximity of vehicle 502. The one or more alerts may be displayed by V2X communications system 504, which may be a distraction to the driver of vehicle 502. The distraction may be particularly problematic in the event that additional pedestrians enter vehicle 502, as shown in FIG. 8.

Referring to FIG. 8, a diagram 800 illustrating a fourth P2V communication scenario involving pedestrian 510 and vehicle 502 of FIGS. 5, 6, and 7 is shown, occurring at a time after the third P2V communication scenario of FIG. 7. In FIG. 8, pedestrian 510 is a first passenger in vehicle 502, and mobile device 508 transmits a first set of PSMs 806 which is received by V2X communications system 504. In response to receiving first set of PSMs 806, V2X communications system 504 may display a first set of alerts to the driver of vehicle 502.

In the fourth P2V communication scenario shown in FIG. 8, a second pedestrian 810 has entered vehicle 502 as a second passenger of vehicle 502. Second pedestrian 810 has a second mobile device 808, which may be a non-limiting example of pedestrian mobile device 142, which like mobile device 508 is configured to communicate via P2V/V2P communications with vehicle 502. As with pedestrian 510, when second pedestrian 810 enters vehicle 502, mobile device 808 continues to transmit PSM messages. In particular, mobile device 808 transmits a second set of PSMs 816, which are received at V2X communications system 504. As second set of PSMs 816 are received at V2X communications system 504, V2X communications system 504 may determine that pedestrian 810 is within the threshold proximity of vehicle 502, whereby V2X communications system 504 may erroneously display a second set of alerts to the driver of vehicle 502. The second set of alerts may be displayed by V2X communications system 504, in addition to the first set of alerts.

A third pedestrian 812 has a third mobile device 818, which may be a non-limiting example of pedestrian mobile device 142, which like mobile device 508 and second mobile device 808 is configured to communicate via P2V/V2P communications with vehicle 502. Third mobile device 818 transmits a third set of PSMs 826, which are received at V2X communications system 504. As third set of PSMs 826 are received at V2X communications system 504, V2X communications system 504 may predict a first trajectory of pedestrian 812 and a first speed of pedestrian 812. V2X communications system 504 may further predict that the first trajectory of pedestrian 812 intersects with a second trajectory of vehicle 502, as described above, such that a probability of vehicle 502 being within the threshold proximity of pedestrian 812 at an intersection point of the first trajectory and the second trajectory may be high. As a result, V2X communications system 504 may display a third alert to the driver of vehicle 502.

However, the third alert may not be noticed by the driver, as a result of a distraction of the first set of alerts and the second set of alerts erroneously generated by mobile device 508 and second mobile device 808. For example, the third alert may be obfuscated by one or more alerts of the first and second set of alerts. Because the first and second alerts may be managed based on a predicted time or distance to a potential collision, the first and second set of alerts may take precedence over the third alert, due to mobile device 508 and second mobile device 808 being closer in proximity to V2X communications system 504 than third mobile device 818. Additionally or alternatively, the third alert may not stand out among a plurality of alerts, or all of the alerts may be ignored by the driver, who may feel bombarded by alerts. As a result of not noticing the third alert, a risk to a safety of third pedestrian 812 may be increased. The risk is further increased in the case where vehicle 502 may carry a number of passengers, such as a public bus.

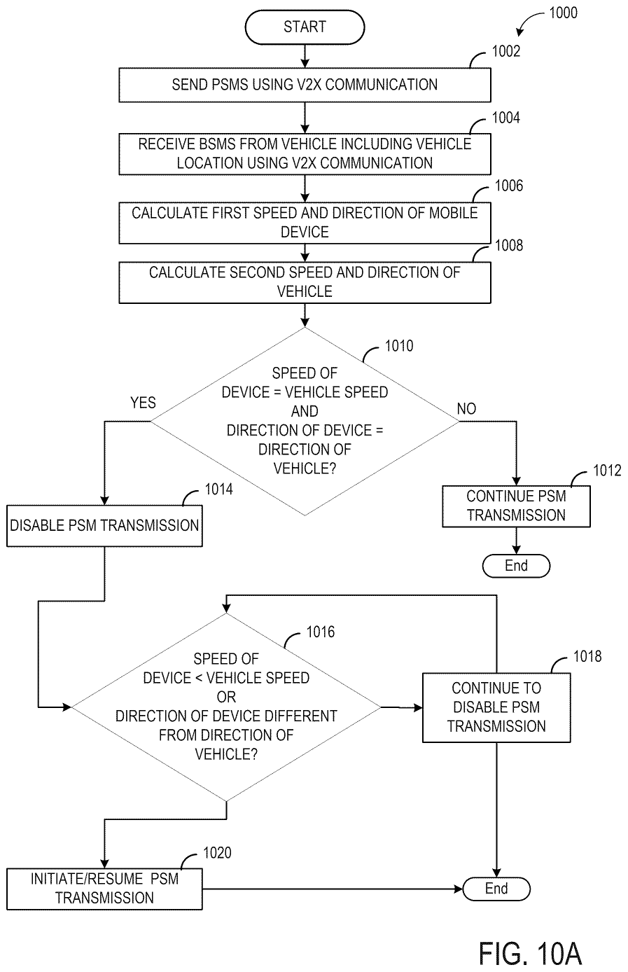

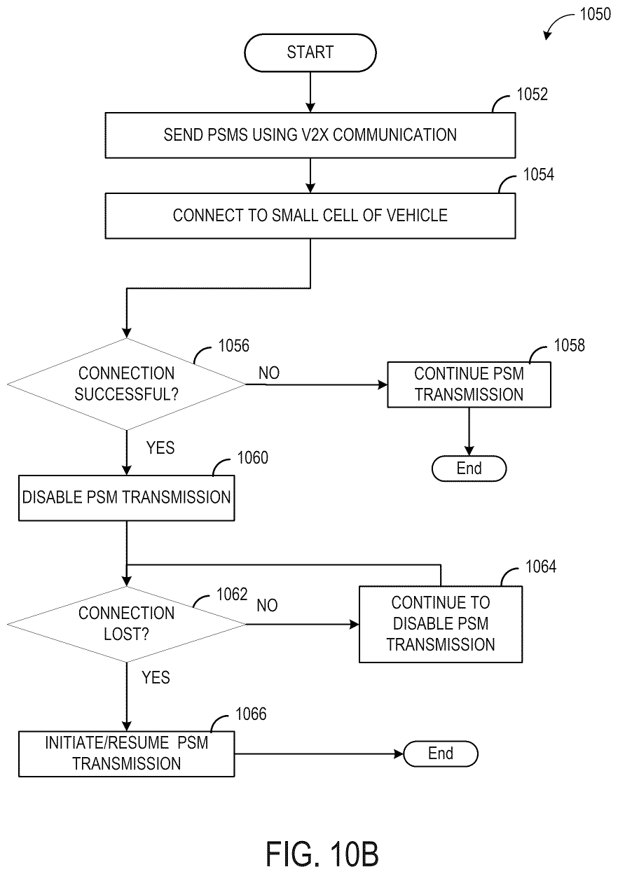

To address the problem of alerts being erroneously generated by V2X communications system 504 in response to pedestrians 510 and 810 entering vehicle 502 as passengers, a method is provided for determining when pedestrians 510 and 810 are inside vehicle 502 and travelling with vehicle 502 as passengers rather than pedestrians outside the vehicle, whereby transmission of the first and second set of PSMs may be disabled. The method for determining when pedestrians 510 and 810 are inside vehicle 502 and travelling with vehicle 502 as passengers rather than pedestrians outside the vehicle is described below in reference to FIGS. 10A and 10B.

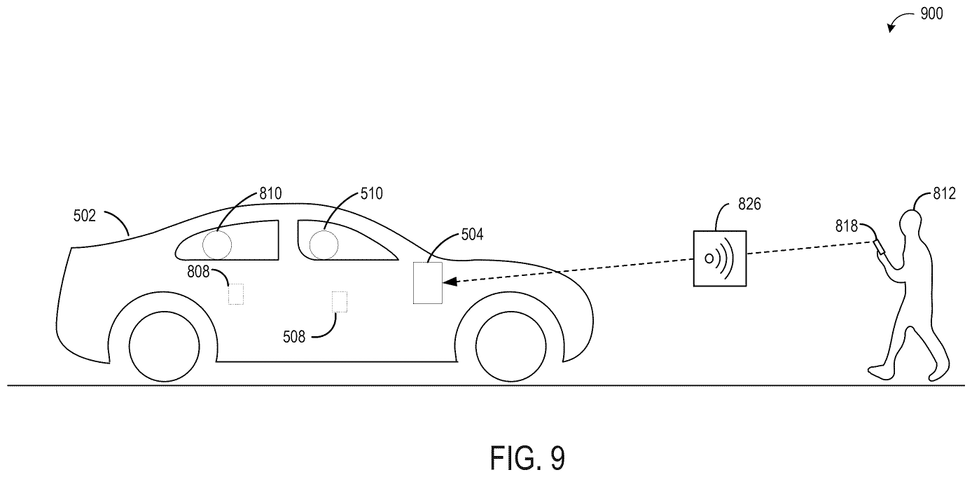

FIG. 9 shows a diagram 900 illustrating a fifth P2V communication scenario involving pedestrian 510 and vehicle 502 of FIGS. 5, 6, 7, and 8, where fifth P2V communication scenario addresses the problem of alerts being erroneously generated by V2X communications system 504 in response to pedestrians 510 and 810 entering vehicle 502 by applying one or more of the methods of FIGS. 10A and 10B. In contrast to FIG. 8, in FIG. 9, mobile device 508 of pedestrian 510 has disabled transmission of the first set of PSMs, which are no longer received at V2X communications system 504. Second mobile device 808 of second pedestrian 810 has also disabled transmission of the second set of PSMs, which are no longer received at V2X communications system 504. As a result of not receiving the first set of PSMs and the second set of PSMs, V2X communications system 504 may no longer display the first set of alerts and the second set of alerts. As a result of the first set of alerts and the second set of alerts not being displayed, the third alert generated by V2X communications system 504 in response to the probability of vehicle 502 being within the threshold proximity of third pedestrian 812 at the intersection point of the first trajectory and the second trajectory may be noticed by the driver, who may take precautionary measures to increase a safety of third pedestrian 812 and the driver.

FIGS. 10A and 10B show two methods for controlling V2X communications between a mobile device of a pedestrian and a vehicle (P2V) near the pedestrian, where the vehicle approaches the pedestrian, picks up the pedestrian (e.g., the pedestrian is a passenger), and drops off the pedestrian at a later time (e.g., at a different location). In some embodiments, a first method of the two methods (e.g., FIG. 10A) may be used, and in other embodiments, a second method of the two methods (e.g., FIG. 10B) may be used. In still other embodiments, both of the first method and the second method may be used in conjunction. The vehicle may be similar to, or the same as, the vehicle 101 described above with reference to FIG. 1, the vehicle 202 described above with reference to FIGS. 2 and 3, and/or vehicle 502 described above with reference to FIGS. 5-9. The V2X communications, which are described further below, may be similar to, or the same as, the P2V communications described above with reference to FIGS. 5-9. Instructions for carrying out the methods may be executed by a processor of a mobile device, such as processor 146 of pedestrian mobile device 142 of FIG. 1, based on instructions stored in a memory (e.g., non-transitory memory 144) of the mobile device.

Referring now to FIG. 10A, a flowchart illustrating a first method 1000 for controlling the V2X communications between the mobile device of the pedestrian and the vehicle is shown.

At 1002, method 1000 includes broadcasting PSMs from the mobile device, which may be received at one or more vehicles and/or devices (e.g., RSUs, other pedestrian devices, etc.) configured for V2X communication. The PSMs may be transmitted by a V2X application installed on the mobile device, such as P2V application 148 of FIG. 1. In various embodiments, the PSMs may be transmitted via a transceiver of the mobile device automatically when the mobile device is switched on, and may be transmitted at regular intervals, such as, for example, at 100 ms intervals. The PSMs may include information of the mobile device, including but not limited to location data of the mobile device (e.g., a latitude, longitude, and an elevation of the mobile device). In various embodiments, the location data may be provided by a GPS of the mobile device.

At 1004, method 1000 includes receiving a plurality of BMSs from the vehicle using V2X communication. The BSMs may be transmitted by a V2X system of the vehicle, such as V2X system 108 of FIG. 1. In various embodiments, the BSMs may be transmitted via a communication module (e.g., a transceiver) of the vehicle, such as communication module 110 of FIG. 1, at regular intervals (e.g., 100 ms intervals. The BSMs may include information of the vehicle, including but not limited to location data of the vehicle (e.g., a latitude, longitude, and an elevation of the vehicle). In various embodiments, the location data may be provided by a GPS of the vehicle (e.g., GPS 114).

At 1006, method 1000 includes calculating a first speed and first direction of the mobile device. In some embodiments, the first speed and first direction of the mobile device may be calculated based on a change in the location of the mobile device over a duration, where the change in location is determined from a location measurements provided by the GPS of the mobile device. For example, a first location of the mobile device at a first time may be stored in a memory of the mobile device (e.g., non-transitory memory 144). The first location may be compared to a second location of the mobile device at a second time (e.g., a current location), after a first duration. A difference between the first location and the second location may be used to calculate the first direction. The difference and the first duration may be used to calculate the first speed. The first speed may also be extracted from National Marine Electronics Association (NMEA) strings included in the GPS data.

Additionally or alternatively, the speed of the mobile device may be calculated using an accelerometer of the mobile device, in accordance with various techniques known in the art. For example, an initial velocity of zero may be assumed, and accelerations measured via the accelerometer may be tracked and combined or averaged to generate an estimated acceleration over a duration, and an integration of the estimated acceleration may be performed to derive the velocity of the mobile device. In still other embodiments, the speed and/or direction may be retrieved from one or more smart apps installed on the mobile device. As described above, the first direction may be used by a receiving vehicle to determine a trajectory of the pedestrian. In some embodiments, the direction may be derived from GPS data (angle, yaw rate).

At 1008, method 1000 includes calculating a speed and direction of the vehicle. The speed and the direction of the vehicle may be calculated based on a change in the location of the vehicle over a second duration in a manner similar to that described above in relation to the mobile device, where the change in location is determined from a plurality of locations included in a respective plurality of BSMs transmitted by the vehicle over the second duration. The second duration may be equal to the first duration, or different from the first duration.

At 1010, method 1000 includes determining whether the first speed of the mobile device is equal to (e.g., within a threshold speed difference of) the second speed of the vehicle, and whether the first direction of the mobile device is equal to (e.g., within a threshold direction difference of) the second direction of the vehicle. In one example, the threshold speed difference is 3 mph, and the threshold direction difference is +/−5 degrees (over a distance of less than 1 meter).

If a difference between the first speed and the second speed is less than the threshold speed difference, and a difference between the first direction and the second direction is less than the threshold direction difference, it may be inferred that the pedestrian has entered the vehicle. Alternatively, if the first speed is different from the second speed by more than the threshold speed difference or the first direction is different from the second direction by more than the threshold direction difference, it may be inferred that the pedestrian has not entered the vehicle.

In some examples, the first speed of the mobile device may additionally or alternatively be compared to a threshold speed, which may be an estimated maximum walking speed of the pedestrian. Thus, when the speed of the mobile device is greater than the threshold speed, the pedestrian is travelling at a speed of a vehicle, whereby it may be inferred that the pedestrian has entered the vehicle. An advantage of determining whether the pedestrian has entered the vehicle based on comparing the first speed and the second speed is that the determination may be more accurate than comparing the speed of the mobile device with the threshold speed. However, an advantage of comparing the speed of the mobile device with the threshold speed is that it may be determined whether the pedestrian is walking. A determination of whether the pedestrian is running may be made based on data included in one or more apps/smart gadgets connected to the mobile device.

If at 1010 it is determined either that the difference between the first speed and the second speed is greater than the threshold speed difference (e.g., the first speed and the second speed are different), or the difference between the first direction and the second direction is greater than the threshold direction difference (e.g., the first direction and the second direction are different), method 1000 proceeds to 1012. At 1012, method 1000 includes continuing to transmit PSMs, and method 1000 ends.

Alternatively, if at 1010 it is determined both that the difference between the first speed and the second speed is less than the threshold speed difference and the difference between the first direction and the second direction is less than the threshold direction difference, method 1000 proceeds to 1014.

At 1014, method 1000 includes disabling PSM transmission, whereby PSMs are no longer transmitted by the mobile device. As a result of the PSMs no longer being transmitted, alerts may not be generated for a driver of the vehicle based on a misconception that the passenger is a pedestrian outside the vehicle who has entered a threshold proximity of the vehicle. At this time, the pedestrian is riding in the vehicle.

At 1016, method 1000 includes determining whether the first speed of the mobile device decreases below the second speed of the vehicle, or whether the first direction of the mobile device is different from the second direction of the vehicle. If either the first speed decreases below the second speed or the first direction is different from the second direction, it may be inferred that the pedestrian has exited the vehicle and is no longer travelling in the vehicle. Alternatively, if the first speed is the equal to the second speed and the first direction is equal to the second direction, it may be inferred that the pedestrian is in the vehicle and (still) riding as a passenger (e.g., has not exited the vehicle).

If at 1016 it is determined both that the first speed of the mobile device is equal to the second speed of the vehicle and that the first direction of the mobile device is equal to the second direction of the vehicle, method 1000 proceeds to 1018.

At 1018, method 1000 includes continuing to disable the PSM transmissions, to ensure that alerts are not generated for the driver relating to the pedestrian/passenger, and method 1000 proceeds back to 1016.

Alternatively, if at 1016 it is determined either that the first speed of the mobile device is less than the second speed of the vehicle or that the first direction of the mobile device is different from the second direction of the vehicle, method 1000 proceeds to 1020. At 1020, method 1000 includes initiating or resuming transmitting the PSMs, and method 1000 ends.

Thus, by comparing the first speed and first direction of the mobile device of the pedestrian with the second speed and second direction of the vehicle, it may be determined whether the pedestrian is riding in the vehicle or is outside the vehicle. If the pedestrian is determined to be in the vehicle, the PSMs are disabled until the first speed and first direction of the mobile device deviate from the second speed and second direction of the vehicle. When the first speed and first direction deviate from the second speed and the second direction, respectively, it may be inferred that the pedestrian has exited the vehicle, and PSM transmission is restarted. In this way, the PSMs may be generated at the mobile device when the pedestrian is walking in a vicinity of the vehicle, and the PSMs may not be generated when the pedestrian gets into the vehicle. As a result, the alerts may be generated when the pedestrian is within a threshold distance of the vehicle, but not when inside the vehicle.

Referring now to FIG. 10B, a flowchart illustrating a second method 1050 for controlling the V2X communications between the mobile device of the pedestrian and the vehicle is shown. Second method 1050 may be used as an alternative to, or in conjunction with first method 1000 of FIG. 10A. However, unlike first method 1000, second method 1050 may rely on a small cell (e.g., a femtocell) or a different wireless device being installed in the vehicle.

At 1052, method 1050 includes broadcasting PSMs from the V2X application installed on the mobile device, as described above. In various embodiments, the PSMs may be transmitted via a transceiver of the mobile device automatically when the mobile device is switched on, and may be transmitted at regular intervals, such as, for example, at 100 ms intervals.

At 1054, method 1050 includes connecting wirelessly to the small cell (or different wireless device) installed in the vehicle. The mobile device may be configured to automatically connect to the small cell when a distance between the mobile device and the small cell is less than a threshold connection distance, where the threshold connection distance is less than a second distance from the small cell to an exterior of the vehicle. Thus, when the mobile device enters the vehicle, the mobile device may connect to the small cell, but the mobile device may not connect to the small cell when the mobile device is outside the vehicle.

At 1056, method 1050 includes determining whether the mobile device is connected to the small cell of the vehicle. If the mobile device is connected to the small cell of the vehicle, it may be inferred that the pedestrian has entered the vehicle and is riding as a passenger in the vehicle. Alternatively, if the mobile device is not connected to the small cell of the vehicle, it may be inferred that the pedestrian has not entered the vehicle and is outside the vehicle.

If at 1056 it is determined that the mobile device is not connected to the small cell, method 1050 proceeds to 1058. At 1058, method 1050 includes continuing to transmit PSMs, and method 1050 ends. Alternatively, if at 1056 it is determined that the mobile device is connected to the small cell, method 1050 proceeds to 1060.

At 1060, method 1050 includes disabling PSM transmission, whereby PSMs are no longer transmitted by the mobile device. As a result of the PSMs no longer being transmitted, alerts may not be generated for a driver of the vehicle based on a misconception that the passenger is a pedestrian outside the vehicle who has entered a threshold proximity of the vehicle.

At 1062, method 1050 includes determining whether the connection established with the small cell has been lost, where the mobile device is not connected to the small cell of the vehicle. Determining whether the connection has been lost may include determining whether a duration has passed without the connection being re-established, to address temporary network issues. For example, the duration may be 60 seconds.

If at 1062 it is determined that the connection has not been lost (e.g., the mobile device is connected to the small cell of the vehicle), method 1050 proceeds to 1064.

At 1064, method 1050 includes continuing to disable the PSM transmissions, to ensure that alerts are not generated for the driver relating to the pedestrian/passenger, and method 1050 proceeds back to 1062 to monitor the connection.

Alternatively, if at 1062 it is determined that the connection has been lost (e.g., the mobile device is not connected to the small cell of the vehicle), method 1050 proceeds to 1066. At 1066, method 1050 includes initiating or resuming transmitting the PSMs, and method 1050 ends.

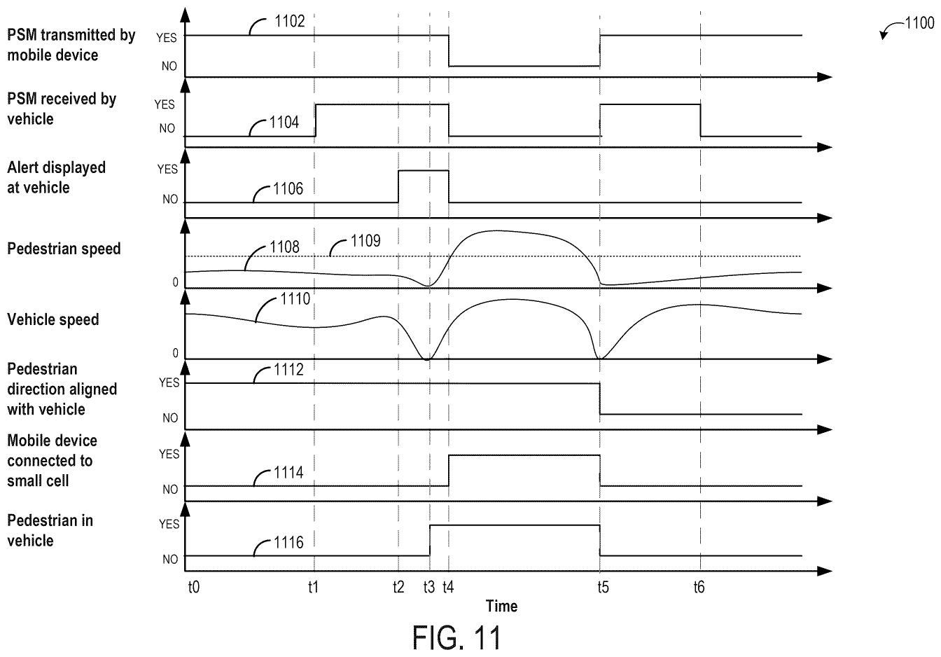

FIG. 11 shows a timing diagram 1100 that illustrates a sequence of events that occur as a vehicle briefly transports the pedestrian from a first location to a second location where the pedestrian exits the vehicle, where the vehicle and a mobile device of the pedestrian are configured to transmit and receive V2X communications. In particular, timing diagram 1100 shows a transmission of PSMs from the mobile device to the vehicle as the vehicle approaches the pedestrian. The horizontal (x-axis) denotes time and the vertical lines t1-t7 identify significant times in the sequence of events.

Timing diagram 1100 includes eight plots. A first plot, line 1102, indicates whether PSMs are being transmitted by the mobile device, where YES indicates that the PSMs are being transmitted, and NO indicates that the PSMs are not being transmitted. A second plot, line 1104, indicates whether PSMs transmitted by the mobile device are being received by the vehicle, where YES indicates that the PSMs are being received by the vehicle, and NO indicates that the PSMs are not being received. A third plot, line 1106, indicates whether an alert is displayed at the vehicle (e.g., on a dashboard display screen such as display screen 116 of FIG. 1), where YES indicates that one or more alerts are displayed, and NO indicates that no alerts are displayed. A fourth plot, line 1108, indicates a speed of the pedestrian, who may be walking or riding in the vehicle. A dotted line 1109 indicates a threshold speed, which may be an estimated maximum walking speed. A fifth plot, line 1110, indicates a speed of the vehicle. A sixth plot, line 1112, indicates whether a first direction of the pedestrian and second direction of the vehicle are aligned, where YES indicates that the first direction is aligned with the second direction, and NO indicates that the first direction is not aligned with the second direction. A seventh plot, line 1114, indicates whether the mobile device has established a wireless connection with a small cell of the vehicle, where YES indicates that the mobile device is connected, and NO indicates that the mobile device is not connected. An eighth plot, line 1116, indicates whether the pedestrian is in the vehicle, where YES indicates that the pedestrian is in the vehicle, and NO indicates that the pedestrian is not in the vehicle.

In timing diagram 1100, between a time t0 and a time t1, the pedestrian is walking (e.g., on a sidewalk next to a road, such as road 503 of FIG. 5) and not in the vehicle, and the mobile device carried by the pedestrian is transmitting PSMs. However, the PSMs are not received at the vehicle, as shown by line 1104, as the pedestrian is outside a range of the PSMs. The vehicle is travelling at a greater speed than the pedestrian.

At time t1, the vehicle enters the range of the mobile device, and the PSMs are received at the vehicle. However, no alerts may be generated, as a distance between the pedestrian and the vehicle may be greater than a threshold distance for generating the alerts. Between time t1 and t2, the vehicle continues to approach the pedestrian. The pedestrian and the vehicle are traveling in the same direction.

At a time t2, the distance between the vehicle and the pedestrian may be equal to the threshold distance, and one or more alerts are displayed to a driver of the vehicle warning that the pedestrian may be in close proximity to the vehicle. As described above, in some embodiments, an alert may be generated based on a determination that a first predicted trajectory of the pedestrian may intersect with a second predicted trajectory of the vehicle.

Between time t2 and a time t3, the pedestrian (walking) slows down in anticipation of being picked up by the vehicle, and the vehicle slows down in anticipation of picking up the pedestrian. At time t3, the pedestrian enters the vehicle and becomes a passenger.

Between time t3 and a time t4, the vehicle speeds up, with the passenger inside. By time t4, a P2V application running on the mobile device (e.g., P2V application 148 of FIG. 1) determines that the speed of the pedestrian is equal to the speed of the vehicle, for example, by following method 1000 of FIG. 10A. Concurrently, the mobile device connects to the small cell installed in the vehicle. At time t4, the speed of the mobile device achieves a threshold speed indicated by line 1109, (e.g., a speed greater than a walking speed of the pedestrian and within a range of a vehicle speed), and the mobile device is connected to the small cell.

In response to determining that the speed of the pedestrian is equal to the speed of the vehicle, the pedestrian achieving the threshold speed, and/or the mobile device connecting to the wireless device, it is inferred that that the pedestrian is travelling in the vehicle. As a result, the transmission of the PSMs by the mobile device is disabled, and no PSMs are received at the vehicle. As a result of not receiving the PSMs, no alerts may be displayed to the driver of the vehicle.

Between time t4 and a time t5, no PSMs are transmitted by the mobile device or received by the vehicle, the mobile device remains connected to the wireless device of the vehicle, no alerts are displayed, and the vehicle and pedestrian continue traveling at a speed greater than the threshold speed. As the vehicle approaches time t5, the vehicle slows down in anticipation of dropping of the pedestrian/passenger.

At time t5, the vehicle drops off the pedestrian/passenger, who exits the vehicle. The speed of the vehicle increases to a higher speed, while the pedestrian begins to walk away from the vehicle at a lower speed (e.g., below the threshold speed). Thus, the speed of the pedestrian and the speed of the vehicle are no longer equal. The pedestrian walks away from the vehicle in a direction different from the direction of the vehicle, as shown by line 1112. When the pedestrian exits the vehicle, the mobile device of the pedestrian disconnects from the small cell (e.g., the connection is lost). As a result of the speed of the pedestrian no longer being equal to the speed of the vehicle (and/or being below the threshold speed), the direction of the pedestrian being different from the direction of the vehicle, and/or the mobile device not being connected to the small cell, PSM transmission from the mobile device is enabled, and PSM are transmitted by the mobile device.

Between time t5 and t6, PSMs continue to be transmitted by the mobile device and received by the vehicle. However, alerts may not be generated, as a result of the pedestrian not being within a threshold proximity of the vehicle. At time t6, the vehicle is out of range of the mobile device, whereby the vehicle no longer receives the PSMs transmitted by the vehicle.

Thus, as described herein, various methods are disclosed for determining whether a pedestrian has entered a vehicle, based on comparing a speed of a mobile device with a speed of the vehicle, comparing a direction of the mobile device with a direction of the vehicle, comparing the speed of the mobile device with a threshold speed, or detecting a wireless connection established between the mobile device and the vehicle, or any combination thereof. By determining whether the pedestrian has entered the vehicle, PSMs generated by the mobile device of the pedestrian may be advantageously disabled when the pedestrian is not at risk, such that alerts may not be generated at the vehicle for a driver of the vehicle. In this way, unnecessary alerts generated by a passenger of the vehicle may be prevented, increasing a safety of the driver and other pedestrians that may be in a vicinity of the vehicle.

The technical effect of disabling PSMs generated by a mobile device when it is detected that the mobile device is inside a vehicle is that alerts may not be generated for a driver of the vehicle, which may confuse the driver or obfuscate alerts related to other pedestrians.

The disclosure also provides support for a method for a mobile device, comprising: periodically transmitting Pedestrian Safety Messages (PSMs) to a vehicle, the PSMs including information used by the vehicle to determine whether to display an alert to a driver of the vehicle, and in response to detecting that the mobile device is inside the vehicle, stopping transmitting of the PSMs. In a first example of the method, stopping transmitting of the PSMs includes maintaining the PSMs in a stopped state and not transmitting the PSMs while the mobile device is detected inside the vehicle. In a second example of the method, optionally including the first example, detecting that the mobile device is inside the vehicle further comprises: determining a first speed and a first direction of the mobile device over a first duration, determining a second speed and a second direction of the vehicle over a second duration, in response to a first difference between the first direction and the second direction being less than a threshold direction difference, and at least one of: a second difference between the first speed of the mobile device and the second speed of the vehicle being less than a threshold speed difference, and the first speed being greater than a threshold speed, determining that the mobile device is inside the vehicle. In a third example of the method, optionally including one or both of the first and second examples, the first direction of the mobile device is calculated based on a change in a location of the mobile device over the first duration, the location of the mobile device determined using a global positioning system (GPS) of the mobile device. In a fourth example of the method, optionally including one or more or each of the first through third examples, the second direction of the vehicle is calculated based on a change in a location of the vehicle over the second duration, the location of the vehicle included in a plurality of Basic Safety Messages (BSMs) transmitted from the vehicle over the second duration. In a fifth example of the method, optionally including one or more or each of the first through fourth examples, the first speed of the mobile device is calculated based on the change in the location of the mobile device over the first duration. In a sixth example of the method, optionally including one or more or each of the first through fifth examples, the first speed of the mobile device is determined based on data received from one or more smart apps of the mobile device and/or smart devices connected to the mobile device. In a seventh example of the method, optionally including one or more or each of the first through sixth examples, the first speed of the mobile device is calculated based on data received from an accelerometer of the mobile device. In a eighth example of the method, optionally including one or more or each of the first through seventh examples, detecting that the mobile device is inside the vehicle further comprises detecting a wireless connection between the mobile device and a wireless device of the vehicle. In a ninth example of the method, optionally including one or more or each of the first through eighth examples, the wireless device is a small cell. In a tenth example of the method, optionally including one or more or each of the first through ninth examples, the small cell is a femtocell. In a eleventh example of the method, optionally including one or more or each of the first through tenth examples, the method further comprises: after stopping the transmitting of the PSMs, starting transmitting of the PSMs in response to at least one of: the first difference between the first direction and the second direction being greater than the threshold direction difference, the second difference between the first speed of the mobile device and the second speed of the vehicle being greater than the threshold speed difference, and the wireless connection between the mobile device and the wireless device of the vehicle not being detected. In a twelfth example of the method, optionally including one or more or each of the first through eleventh examples, the PSMs are transmitted in accordance with SAE Surface Vehicle Standard J2735.

The disclosure also provides support for a mobile device, comprising: a processor, and a non-transitory memory including instructions stored thereon that when executed, cause the processor to: periodically transmit Pedestrian Safety Messages (PSMs) via a Pedestrian-to-Vehicle (P2V) application of the mobile device, determine a first speed and a first direction of the mobile device, determine a second speed and a second direction of a vehicle receiving the PSMs, in response to a first difference between the first direction and the second direction being less than a threshold direction difference and a second difference between the first speed of the mobile device and the second speed of the vehicle being less than a threshold speed difference, stop transmitting of the PSMs, in response to the first difference between the first direction and the second direction being greater than the threshold direction difference and the second difference between the first speed of the mobile device and the second speed of the vehicle being greater than a threshold speed difference, resume transmitting the PSMs. In a first example of the system, the first speed and the first direction of the mobile device are determined based on a change of location of the mobile device, the location of the mobile device provided by a global positioning system (GPS) of the mobile device, and the second speed and the second direction of the vehicle are determined based on a change of location of the vehicle, the location of the vehicle included in Basic Safety Messages (BSMs) transmitted by the vehicle and received at the mobile device. In a second example of the system, optionally including the first example, the first speed is determined based on data received from one or more smart apps of the mobile device and/or data received from an accelerometer of the mobile device. In a third example of the system, optionally including one or both of the first and second examples, further instructions are included in the non-transitory memory that when executed, cause the processor to: stop transmitting the PSMs in response to detecting a wireless connection between the mobile device and a wireless device of the vehicle, and after the PSMs have stopped transmitting, resume transmitting the PSMs in response to not detecting the wireless connection between the mobile device and the wireless device of the vehicle. In a fourth example of the system, optionally including one or more or each of the first through third examples, the wireless device is a small cell installed in the vehicle.

The disclosure also provides support for a method, comprising: periodically transmitting Pedestrian Safety Messages (PSMs) from a mobile device carried by a pedestrian, the PSMs received by a vehicle within a range of the mobile device, in response to a distance between the vehicle and the mobile device decreasing below a threshold distance: in a first condition, where a first speed difference between a speed of the vehicle and a speed of the mobile device is greater than a threshold speed difference, and a second direction difference between a direction of the vehicle and a direction of the mobile device is greater than a threshold direction difference, an alert is generated at the vehicle notifying a driver of the vehicle of the pedestrian based on a PSM received by the vehicle, in a second condition, where the first speed difference is less than the threshold speed difference and the second direction difference is less than the threshold direction difference, the transmitting of the PSMs is disabled and the alert is not generated at the vehicle, and in a third condition, where the mobile device establishes a wireless connection to a wireless device of the vehicle, the transmitting of the PSMs is disabled and the alert is not generated at the vehicle. In a first example of the method, the method further comprises: after disabling the transmitting of the PSMs: in a fourth condition, where the first speed difference is greater than the threshold speed difference, and the second direction difference is greater than the threshold direction difference, the transmitting of the PSMs is enabled, and in a fifth condition, where the wireless connection between the mobile device and the wireless device of the vehicle is lost, the transmitting of the PSMs is enabled.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The methods may be performed by executing stored instructions with one or more logic devices (e.g., processors) in combination with one or more additional hardware elements, such as storage devices, memory, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” and so on. are used merely as labels, and are not intended to impose numerical requirements or a particular positional order on their objects. The following claims particularly point out subject matter from the above disclosure that is regarded as novel and non-obvious.

1. A method for a mobile device, comprising:
periodically transmitting Pedestrian Safety Messages (PSMs) to a vehicle, the PSMs including information used by the vehicle to determine whether to display an alert to a driver of the vehicle; and
in response to detecting that the mobile device is inside the vehicle, stopping transmitting of the PSMs.

2. The method of claim 1, wherein stopping transmitting of the PSMs includes maintaining the PSMs in a stopped state and not transmitting the PSMs while the mobile device is detected inside the vehicle.

3. The method of claim 1, wherein detecting that the mobile device is inside the vehicle further comprises:
determining a first speed and a first direction of the mobile device over a first duration;
determining a second speed and a second direction of the vehicle over a second duration;
in response to a first difference between the first direction and the second direction being less than a threshold direction difference, and at least one of:
a second difference between the first speed of the mobile device and the second speed of the vehicle being less than a threshold speed difference; and
the first speed being greater than a threshold speed;
determining that the mobile device is inside the vehicle.

4. The method of claim 3, wherein the first direction of the mobile device is calculated based on a change in a location of the mobile device over the first duration, the location of the mobile device determined based on data from a global positioning system (GPS) of the mobile device.

5. The method of claim 3, wherein the second direction of the vehicle is calculated based on a change in a location of the vehicle over the second duration, the location of the vehicle included in a plurality of Basic Safety Messages (BSMs) transmitted from the vehicle over the second duration.

6. The method of claim 4, wherein the first speed of the mobile device is calculated based on the change in the location of the mobile device over the first duration, the location based on the data from the GPS of the mobile device.

7. The method of claim 4, wherein the first speed of the mobile device is determined based on data received from one or more smart apps of the mobile device and/or smart devices connected to the mobile device.

8. The method of claim 4, wherein the first speed of the mobile device is calculated based on data received from an accelerometer of the mobile device.

9. The method of claim 3, wherein detecting that the mobile device is inside the vehicle further comprises detecting a wireless connection between the mobile device and a wireless device of the vehicle.

10. The method of claim 9, wherein the wireless device is a small cell.

11. The method of claim 10, wherein the small cell is a femtocell.

12. The method of claim 9, further comprising:
after stopping the transmitting of the PSMs, starting transmitting of the PSMs in response to at least one of:
the first difference between the first direction and the second direction being greater than the threshold direction difference;
the second difference between the first speed of the mobile device and the second speed of the vehicle being greater than the threshold speed difference; and
the wireless connection between the mobile device and the wireless device of the vehicle not being detected.

13. The method of claim 1, wherein the PSMs are transmitted in accordance with at least one of:
SAE Surface Vehicle Standard J2735;
SAE Surface Vehicle Standard J3161;
IEEE standard 1609.2;
IEEE standard 1609.3; and
a supporting standard of a region of the mobile device.

14. A mobile device, comprising:
a processor; and
a non-transitory memory including instructions stored thereon that when executed, cause the processor to:
periodically transmit Pedestrian Safety Messages (PSMs) via a Pedestrian-to-Vehicle (P2V) application of the mobile device;
determine a first speed and a first direction of the mobile device;
determine a second speed and a second direction of a vehicle receiving the PSMs;
in response to a first difference between the first direction and the second direction being less than a threshold direction difference and a second difference between the first speed of the mobile device and the second speed of the vehicle being less than a threshold speed difference, stop transmitting of the PSMs;
in response to the first difference between the first direction and the second direction being greater than the threshold direction difference and the second difference between the first speed of the mobile device and the second speed of the vehicle being greater than a threshold speed difference, resume transmitting the PSMs.

15. The mobile device of claim 14, wherein the first speed and the first direction of the mobile device are determined based on data provided by a global positioning system (GPS) of the mobile device, and the second speed and the second direction of the vehicle are determined based on a change of location of the vehicle, the location of the vehicle included in Basic Safety Messages (BSMs) transmitted by the vehicle and received at the mobile device.

16. The mobile device of claim 14, wherein the first speed is determined based on data received from one or more smart apps of the mobile device and/or data received from an accelerometer of the mobile device.

17. The mobile device of claim 14, wherein further instructions are included in the non-transitory memory that when executed, cause the processor to:
stop transmitting the PSMs in response to detecting a wireless connection between the mobile device and a wireless device of the vehicle; and
after the PSMs have stopped transmitting, resume transmitting the PSMs in response to not detecting the wireless connection between the mobile device and the wireless device of the vehicle.

18. The mobile device of claim 17, wherein the wireless device is a small cell installed in the vehicle.

19. A method, comprising:
periodically transmitting Pedestrian Safety Messages (PSMs) from a mobile device carried by a pedestrian, the PSMs received by a vehicle within a range of the mobile device;
in response to a distance between the vehicle and the mobile device decreasing below a threshold distance:
in a first condition, where a first speed difference between a speed of the vehicle and a speed of the mobile device is greater than a threshold speed difference, and a second direction difference between a direction of the vehicle and a direction of the mobile device is greater than a threshold direction difference, an alert is generated at the vehicle notifying a driver of the vehicle of the pedestrian based on a PSM received by the vehicle;
in a second condition, where the first speed difference is less than the threshold speed difference and the second direction difference is less than the threshold direction difference, the transmitting of the PSMs is disabled and the alert is not generated at the vehicle; and
in a third condition, where the mobile device establishes a wireless connection to a wireless device of the vehicle, the transmitting of the PSMs is disabled and the alert is not generated at the vehicle.

20. The method of claim 19, further comprising:
after disabling the transmitting of the PSMs:
in a fourth condition, where the first speed difference is greater than the threshold speed difference, and the second direction difference is greater than the threshold direction difference, the transmitting of the PSMs is enabled; and
in a fifth condition, where the wireless connection between the mobile device and the wireless device of the vehicle is lost, the transmitting of the PSMs is enabled.
